(19) United States
(12) Patent Application Publication
(10) Pub. No.: US 2024/0372295 A1
(43) Pub. Date: Nov. 7, 2024

(54) SECURING ELEMENT FOR A CONNECTOR, CONNECTOR AND CONNECTOR ARRANGEMENT

(71) Applicant: MD Elektronik GmbH, Waldkraiburg (DE)

(72) Inventors: Sabrina SCHNOBRICH, Waldkraiburg (DE); Dimitri MANNHOLD, Muehldorf am Inn (DE); Daniel BOCK, Schoenberg (DE)

(21) Appl. No.: 18/603,421

(22) Filed: Mar. 13, 2024

(30) Foreign Application Priority Data
May 3, 2023 (DE) 10 2023 111 422.0

(51) Int. Cl. H01R 13/627

(52) U.S. Cl. CPC H01R 13/6273

(57) ABSTRACT

A securing element for a connector includes a first and a second arm extending along a first direction. A base connects the first arm and the second arm at a free end. At least a first locking element is disposed on each arm such that the securing element is lockable to the connector in a second direction. At least one second locking element is disposed on each arm such that the securing element is lockable to the connector in a third direction.

### CROSS REFERENCE TO RELATED APPLICATIONS

This application claims benefit to German Patent Application No. DE 10 2023 111 422.0, filed on May 3, 2023, which is hereby incorporated by reference herein.

### FIELD

The invention relates to a securing element for a connector, a connector and a connector arrangement.

### BACKGROUND

In connector systems, a securing element such as a CPA (Connector Position Assurance) is used to prevent unintentional releasing or unlocking of the connector system. In the automotive sector, CPAs are optionally requested by customers. Thereby there is a trend towards the use of CPAs also in small, i.e. narrow and short, connector systems such as mini-coax.

DE 10 2020 127 203 B4 relates to a connector arrangement with a plug-in unit, a securing unit and a mating plug-in unit, in particular for connecting at least one cable to a component, in particular an electrical component. The securing unit thereby has two elastic fastening arms, each of which has a guide pin on the side facing away from the other fastening arm, which is guided in a, in particular linear, guide track of the plug-in unit.

A securing element or CPA must fulfill various requirements, including withstanding or exhibiting different assembly, actuation, misuse and holding forces. In order to achieve or maintain the required forces, most CPAs in the prior art are fitted with a snap-in element, for example guide pins arranged in pairs in specially designed guide tracks. However, it is often difficult to maintain the forces with a snap-in element, because, for example, the assembly forces need to be lower than the disassembly forces.

### SUMMARY

In an embodiment, the present invention provides a securing element for a connector. The securing element includes a first and a second arm extending along a first direction. A base connects the first arm and the second arm at a free end. At least one first locking element is disposed on each arm such that the securing element is lockable to the connector in a second direction. At least one second locking element is disposed on each arm such that the securing element is lockable to the connector in a third direction.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 a perspective view of an embodiment of a securing element;

FIG. 2 a side view of the securing element from FIG. 1;

FIG. 3 a side view of an embodiment of a connector with the securing element in the pre-engagement position;

FIG. 4 a perspective view of the connector from FIG. 3;

FIG. 5 a side view of an embodiment of a connector arrangement in the end-engagement position of the securing element;

FIG. 6 a perspective view of the connector arrangement from FIG. 5; and

FIG. 7 a cross-sectional view of the depiction in FIG. 6.

### DETAILED DESCRIPTION

In an embodiment, the present invention provides a plug-in system, in which the above-mentioned disadvantages are overcome, and which is particularly suitable as a small plug-in system.

In an embodiment, the present invention provides a plug-in system, in which the above-mentioned disadvantages are overcome, and which is particularly suitable as a small plug-in system, by a securing element for a connector comprising a first and a second arm extending along a first direction, a base connecting the first arm and the second arm at a free end, at least a first locking element on each arm, so that the securing element is lockable to the connector in a second direction, and at least a second locking element on each arm, so that the securing element is lockable to the connector in a third direction.

The securing element according to an embodiment of the present invention, also referred to as CPA, has at least first and second locking elements. The at least two locking elements are spatially and functionally independent of each other. In particular, the first and (additional) second locking elements make it possible to independently control different assembly, actuation, misuse and holding forces. In practice, it is common to attach a securing element to a connector in at least two different positions. In a first position, the pre-engagement position, the securing element is attached to the connector. The pre-engagement position serves to prevent the securing element from unintentionally loosening or falling out of the connector. In the pre-engagement position, it is possible to connect a suitable mating connector to the connector. However, without a plugged-in mating connector, the securing element cannot be moved to the second position, the end-engagement position. Only when a mating connector is plugged into the connector can the securing element be moved from the pre-engagement position to the end-engagement position and secure the connection between the connector and the plugged mating connector. The second locking elements on the arms can be used to regulate the locking forces between the pre-engagement and end-engagement positions and/or the pre-engagement and end-engagement. The first locking elements on the arms can be used to (additionally) control the assembly forces and the holding force and/or misuse forces. The combination of first and second locking elements secures the securing element against unintentional release (from the pre-engagement position) from a connector. The extraction force from the pre-engagement position is significantly increased compared to the prior art. This makes disassembly of the securing element more difficult and increases the securing during the drop test. In particular, a tool is required for disassembly.

Preferably, the second direction is arranged transversely, in particular perpendicularly to the third direction, and preferably the second and third directions are arranged transversely, in particular perpendicularly to the first direction. Due to the fact that the first and second locking elements act in different directions, they can be arranged in a space-saving way and function independently of each other. Should the first or second locking element become loose, for example due to the application of strong force, the corresponding other locking element continues to secure the connection. This increases the reliability of the connection. The term connection is used here for the connection between the securing element and the connector, but can be used equally for the connection between the connector and the mating connector.

Preferably, the first arm is flexible and/or the second arm is rigid. In particular, the first arm can be moved and/or bent elastically in any spatial direction. Due to the flexibility of the first arm, it can be used as an unlockable connector protection. The plug-in locking device prevents (unintentional) displacement of the securing element from the pre-engagement position to the end-engagement position if there is not (yet) a mating connector in the plugged-in state. To unlock the plug-in locking device, it can be bent elastically. The rigidity of the second arm allows it to be used as a second guide. Particularly with angled connectors, which are shorter than non-angled connectors, this second guide provides (additional) protection against the locking element tipping out.

Preferably, the first arm can be deflected in the direction of the second arm. The deflection in the plane, in which the first and second arm are already located, is more space-saving than a deflection out of this plane.

Preferably, the first arm has a projection at its free end. The projection can be easily formed and serves as a first bearing point for the main locking element in the end-engagement locking position. By blocking the main locking element with the aid of the projection, unintentional release of the plug-in connection can be prevented. In addition, the projection allows the first arm to be easily deflected by the mating connector.

Preferably, the securing element is asymmetrical in relation to a plane that extends along a central axis in the third direction. The asymmetrical structure offers space for other components, for example, as in the present case on the second arm, such as a secondary locking mechanism. The installation space can thus be optimally utilized, especially for small plug-in systems.

The above-mentioned objects are further achieved in particular by a connector having a first receptacle for receiving a mating connector, a main locking element for locking the connector with the mating connector in the mated state, a second receptacle for receiving a securing element, and a securing element for securing the locking with the mating connector.

Preferably, the connector has at least first openings, with which the first locking elements can be brought into engagement and has second openings, with which the second locking elements can be brought into engagement. The openings on the connector are easy to produce and, together with the first and second locking elements on the securing element, they form a retainer and a positioning of the securing element on the connector.

Preferably, each first opening comprises a continuous area and each second opening comprises at least two separate sub-areas. The two sub-areas of each second opening are used to distinguish between a pre-engagement position and an end-engagement position. In order to move the securing element from one position to the other, an active, directed application of force is necessary, so that unintentional movement is prevented and/or at least made more difficult. The contiguous area of the first opening has the advantage that the forces between the pre-engagement and end-engagement positions are not increased, but the forces between the pre-engagement position and a release of the securing element from the connector are significantly increased. In this way, it is possible to control the (pull-off) forces on the connector.

Preferably, the main locking element is blocked by the securing element at at least one first and one second bearing point in an end-engagement position of the securing element. The blocking at at least two separate points fixes the main locking element even more firmly and makes unintentional release of the plug-in connection even more difficult. This means that the required values for pull-off tests and/or drop tests can also be met for small plug-in systems.

The above-mentioned advantages are furthermore achieved in particular according another embodiment of the present invention by a connector arrangement comprising a connector and a mating connector that can be detachably connected to the connector.

In the following, preferred embodiments are described in detail with reference to the attached figures.

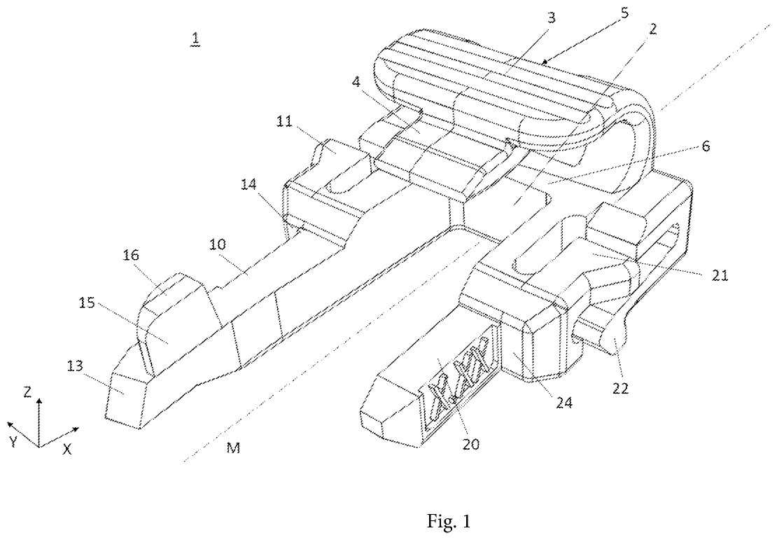

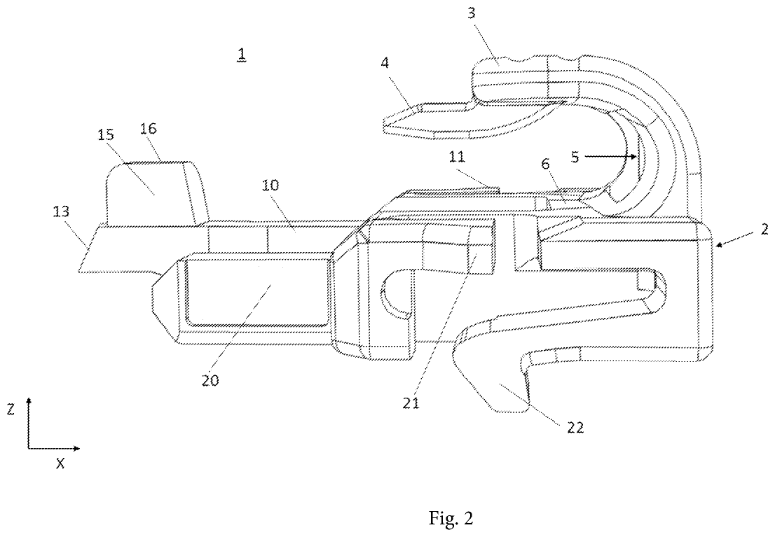

FIG. 1 and FIG. 2 show an embodiment of a securing element 1 for a connector 30. The securing element 1 can be detachably connected to the connector 30 and is intended to secure a connection between the connector 30 and a (fully) plugged-in mating connector 40 against unintentional releasing.

The securing element 1 comprises at least a first and a second arm 10, 20, which extend along a first direction X. In the embodiment shown, the first arm 10 is longer than the second arm 20. In alternative embodiments, other length ratios may occur. The securing element 1 shown therefore has an asymmetrical shape. The asymmetrical shape is relative to a plane that extends along a central axis M and is perpendicular to it in a third direction Z. The central axis M runs in or along the plug-in direction, i.e. the first direction X, of the securing element through the latter (see FIG. 1). The shorter second arm 20 provides space, for example, for a secondary securing element 39 in the connector 30. In the embodiment shown, the first arm 10 is flexible, so that it can be deflected in particular in the direction of the second arm 20. The securing element 1 as a whole, or in particular the first arm 10, is made of a plastic material. The second arm 20 is preferably rigid and serves as a second guide.

The securing element 1 shown further comprises a base 2. The base 2 connects the first arm 10 and the second arm 20 at a free end in each case. A pressure area 3 and at least one button 4 also extend from the base 2. In the embodiment shown, a disassembly opening 5 is also arranged in the transition between the base 2 and the pressure area 3. The assembly personnel can use a tool to move the securing element 1 from the end-engagement position to the pre-engagement position via the disassembly opening 5, so that the connection between the connector 30 and the plugged-in mating connector 40 can be released during disassembly. The assembly personnel can then apply a force via the pressure area 3, in particular along a third direction Z, and actuate the button 4 to release the plug-in connection between connector 30 and mating connector 40. In order to completely release the securing element 1 from the connector 30, the assembly personnel can continue to apply a (greater) force to the securing element 1 via the tool and the disassembly opening 5, preferably along a first direction X (plug-in direction) away from the receptacle 34, and release and/or pull out the securing element 1 from the connector.

Furthermore, the securing element 1 shown has at least one first locking element 11, 21 on each arm 10, 20. The securing element 1 is lockable to the connector 30 in a second direction Y via the first locking element 11, 21. In the embodiment shown, the first locking element 11, 21 is formed by snap-in hooks that extend laterally outwards from each arm 10, 20. For unlocking, the first locking elements 11, 21 are pressed inwards towards the securing element 1. In the basic position, the first locking elements 11, 21 protrude from the securing element 1 and could engage in undercuts.

Furthermore, the securing element 1 shown has at least one second locking element 12, 22 on each arm 10, 20. The securing element 1 is lockable to the connector 30 in a third direction Z via the second locking element 12, 22. In the embodiment shown, the second locking element 12, 22 is formed by snap-in hooks that extend perpendicular to the first locking elements 11, 21 and to the first direction X (see FIG. 2). In particular, the second direction Y is arranged transversely, in particular perpendicularly, to the third direction Z, and preferably the second and third directions Y, Z are arranged transversely, in particular perpendicularly, to the first direction X. In the basic position, the second locking elements 12, 22 protrude from the securing element 1 and could engage in undercuts.

The illustrated first locking elements 11, 21 on the first or second arm 10, 20 can be brought from the basic position into a releasing position by applying an opposing force (towards each other from the outside to the inside) to the securing element 1. The illustrated second locking elements 12, 22 on the first or second arm 10, 20 can be brought from their basic position into a releasing position by applying a force in the same direction (parallel or simultaneously from bottom to top in FIG. 2). The number of different force directions for moving the first and second locking elements 11, 12, 21, 22 from a basic position (engaging position) to a releasing position, i.e. simultaneously pressing in all first and second locking elements 11, 12, 21, 22 in order to release the respective engagement on the connector 30, also makes it more difficult to unintentionally release the securing element 1 from the connector 30. When deliberately removing the securing element 1 from the connector 30, the securing element 1 is normally pulled very strongly (with the aid of a tool) so that the first and second locking elements 11, 12, 21, 22 can be pressed in indirectly under the tensile force on the securing element 1.

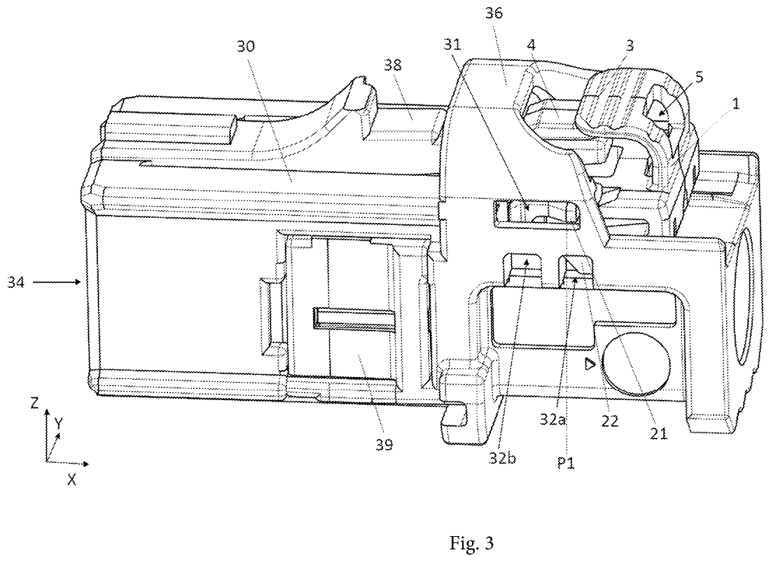

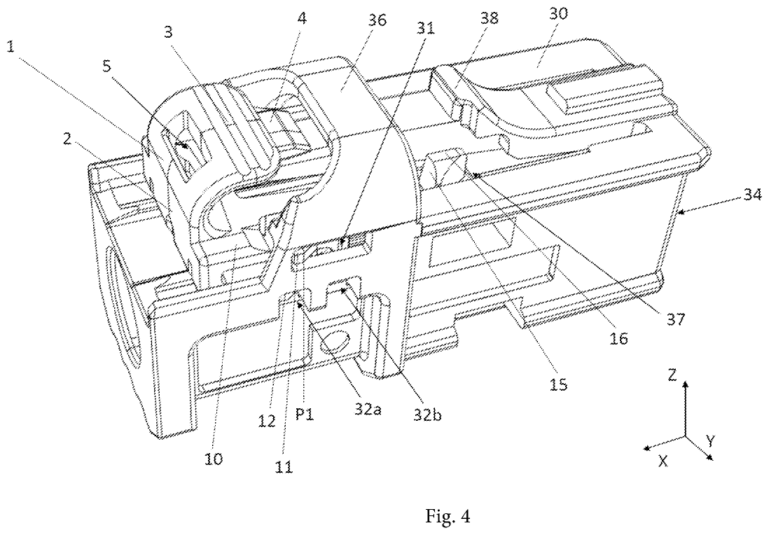

FIGS. 3 and 4 show an embodiment of a connector 30. The connector 30 shown comprises a “female housing” (socket side). The connector 30 is configured to form a plug-in connection with a suitable mating connector 40. For the plug-in connection, connector 30 and mating connector 40 are fully inserted into each other and then secured by the securing element 1.

The connector 30 shown has at least a first receptacle 34 for receiving at least parts of a mating connector 40. The receptacle 34 is formed by an opening on the so-called connector face and then extends inside the connector 30. Electrical contact between the connector 30 and the mating connector 40 is made within the receptacle 34. In order to fasten the connector 30 and the mating connector 40 to one another in the mated state, the connector 30 has a main locking element 38 for locking the connector 30 to the mating connector 40. In the embodiment shown, the main locking element 38 is configured as a snap-in hook that can engage in an undercut and can also be released again for disassembly.

Furthermore, the connector 30 shown has a second receptacle 36 for receiving a securing element 1. In the embodiment shown, the second receptacle 36 is formed by a web or a bridge on the outer side of the connector 30. The second receptacle 36 is intended to give the securing element 1 a hold on the connector 30. In the embodiment shown, the first and second openings 31, 32 are arranged at or in the vicinity of the second receptacle 36. The second receptacle 36 allows insertion of the securing element 1 along the plug-in direction, i.e. the first direction X, of the plug-in connection between the connector 30 and the mating connector 40. Insertion via the first direction X has the advantage that this direction is always available to form the plug-in connection, so that the securing element 1 can be securely and easily fastened to the connector 30 even when the installation space is small. The second receptacle 36 is (spatially and functionally) independent of the first receptacle 34 and is only used to hold the securing element 1 for securing the locking of the connector 30 to the mating connector 40.

Furthermore, the connector 30 shown has at least first openings 31. The number of first openings 31 corresponds to the number of first locking elements 11, 21 on the securing element 1. The first openings 31 each form an undercut, with which the first locking elements 11, 21 can be brought into engagement. Each first opening 31 forms a continuous area. Within the first openings 31, an engaged first locking element 11, 21 can be moved without exerting force. In particular, the first openings 31 are shaped such that a linear movement of the first locking elements 11, 21 from a first position P1 to a second position P2 is possible.

Furthermore, the connector 30 shown has at least also second openings 32. The second openings 32 each form undercuts, with which the second locking elements 12, 22 can be brought into engagement. Each second opening 32 has at least two separate sub-areas, a first and a second sub-area 32a, 32b. The size of each sub-area 32a, 32b is selected such that a form fit with an engaged second locking element 12, 22 is substantially possible. Due to the form fit, the securing element 1 can be held in a certain first or second position P1, P2. A transition between the first and second position P1, P2 is only possible with an exertion of force. This exertion of force requires a deliberate moving of the securing element 1 from one position to another and prevents an accidental moving. In the example shown, the first position P1 corresponds to the pre-engagement position and the second position P2 to the end-engagement position.

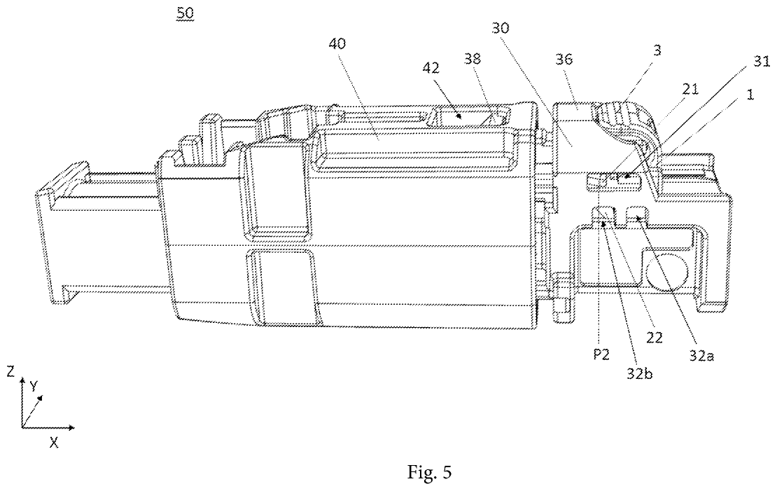

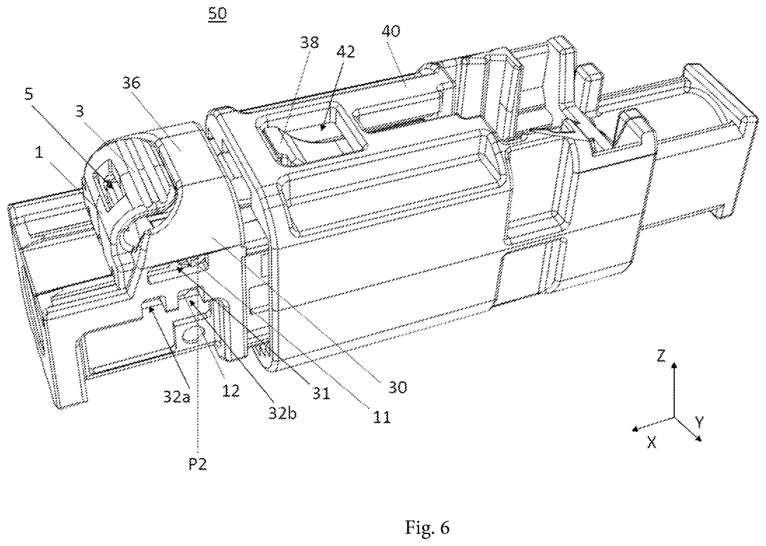

FIGS. 5-7 show an embodiment of a connector arrangement 50, which has a connector 30 and a mating connector 40 (“male housing”), which is detachably connected to the connector 30. In the embodiment shown, connector 30 and mating connector 40 are fully mated and the securing element 1 is in an end-engagement position, thus blocking unintentional release of the plug-in connection.

The following describes an embodiment of the assembly and disassembly of a connector arrangement 50. The securing element 1, the connector 30 and the mating connector 40 are initially separate individual parts. During pre-assembly, securing element 1 and connector 30 may already be pre-assembled. To (pre-) assemble the securing element 1 to the connector 30, the securing element 1 is first inserted with the free end on the first arm 10 into the second receptacle 36 on the connector 30. The securing element 1 is inserted until the first locking elements 11, 21 engage in the respective first opening 31 on the connector 30 and the second locking elements 12, 22 engage in the respective second opening 32 in the first sub-area 32a. All first and second locking elements 11, 12, 21, 22 must be deflected from their basic position in order to reach engagement with the connector 30. When these steps have been carried out, the securing element 1 is in the pre-engagement position. Pre-assembly is now complete.

When the connector 30 and the securing element 1 are in the pre-engagement position, a suitable mating connector 40 can be plugged in along the first direction X with the connector 30. When the mating connector 40 is plugged into the connector 30, the first arm 10 is deflected inwardly towards the second arm 20 by the mating connector 40. The deflection is thereby so strong that the first arm 10, which in the pre-engagement position still rests with its first stop 13 against a blocking element 37 of the connector 30 and is prevented from moving further into the end-engagement position, is guided past the blocking element 37 and can thus be moved into the end-engagement position. During the movement for the complete mating of connector 30 and mating connector 40, the main locking element 38 is briefly deflected from its basic position in the third direction Z towards connector 30 and then snaps back into its basic position within the snap-in opening 42 on mating connector 40. When the connector 30 and the mating connector 40 are fully mated, the main locking element 38 and the snap-in opening 42 are engaged and secure the plug-in connection.

For securing that the main locking element 38 and the snap-in opening 42 engage with each other, the securing element 1 is moved from the pre-engagement position to the end-engagement position. For this purpose, a corresponding force is applied to the securing element 1. The application of force enables the second locking elements 12, 22 to be moved from the respective first sub-area 32a of the second openings 32 into the second sub-area 32b. In practice, due to their (beveled) shape, the second locking elements 12, 22 are simultaneously pushed inwardly towards the connector 30 under the application of the force, then pass the transition between the first sub-area 32a and the second sub-area 32b at each second opening 32 and then snap back into their basic position in the respective second sub-area 32b of the second opening 32 and are thus in engagement with the respective second sub-area 32b. During this movement, the first locking elements 11, 21 are moved without force from their first position P1 to the second position P2. During the movement into the end-engagement position, the button 4 pushes itself into the second receptacle 36 and is thus protected. The end-engagement position is reached when the securing element 1 strikes against the connector 30 with at least a second stop 14, 24.

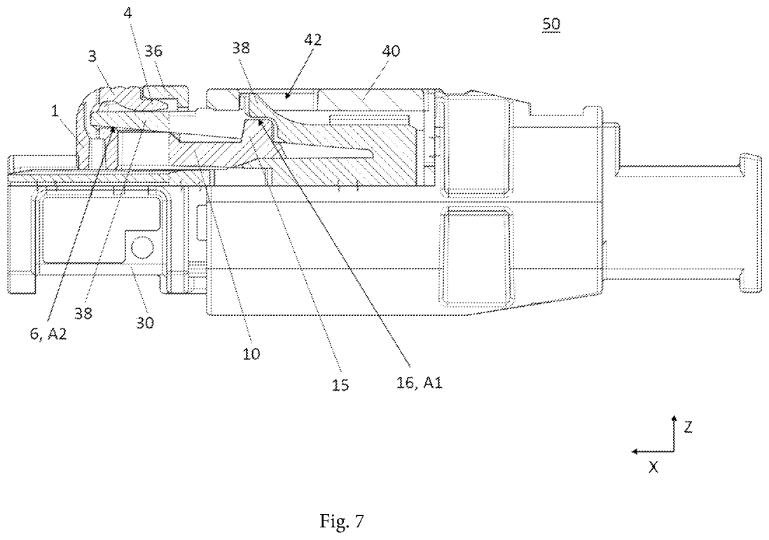

During the described movement from the pre-engagement position to the end-engagement position, the projection 15 on the first arm 10 continues to slide under the main locking element 38 on the connector 30, so that a first bearing surface 16 becomes a first bearing point A1 for the main locking element 38 and the movement of the main locking element 38 in the third direction Z towards the connector 30 is limited and/or blocked. At this point in time, as the main locking element 38 is blocked, it is, however, already in engagement with the snap-in opening 42 on the mating connector 40. The blocking prevents unintentional releasing. The plug-in connection is secured. Furthermore, a part of the base 2 with the second bearing surface 6 of the securing element 1 moves under the main locking element 38 of the connector 30 and forms a second bearing point A2. The main locking element 38 is fixed or blocked in the end-engagement position at at least the first and second bearing points A1, A2 by the securing element 1 (see FIG. 7).

During disassembly, the plug-in connection can only be released by the assembly personnel in a first step using a suitable (disassembly) tool to enter the disassembly opening 5 and to pull the securing element 1 along the first direction X away from the mating connector 40. The securing element 1 is then located back again in the pre-engagement position. From this point on, the mating connector 40 can be released and/or removed again from the connector 30. To do this, a force is exerted on the button 4 via the pressure surface 3. The button 4 releases the engagement of the main locking element 38 from the snap-in opening 42 (because the projection 15 no longer blocks the main locking element 38), so that the mating connector 40 can be released from the connector 30. In order to completely remove the securing element 1 from the connector 30, for example for recycling, the first and second locking elements 11, 12, 21, 22 must be moved from their basic position in order to release the respective engagement with the first and second openings 31, 32 on the connector 30 and then release and/or move the securing element 1 away from the connector 30. The end result is that at least three individual parts, consisting of securing element 1, connector 30 and mating connector 40, are obtained again during disassembly.

Finally, it should be emphasized again how different forces act in the present connection: During assembly, (only) the second locking elements 12, 22 need to be moved from their basic position in order to move the securing element 1 from the pre-engagement position to the end-engagement position. In contrast thereto, during disassembly, on the one hand, a tool is required to move the securing element 1 from the end-engagement position to the pre-engagement position, and, on the other hand, the first and second locking elements 11, 12, 21, 22 must be moved simultaneously from their basic position in order to release the securing element 1 from the connector 30. Thus, different forces (assembly, actuation, misuse, removal and/or holding forces) are controlled on the plug-in connection and accidental release of the plug-in connection is made more difficult.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 securing element
2 base
3 pressure area
4 button
5 disassembly opening
6 second bearing surface
10 first arm
11 first locking element
12 second locking element
13 first stop
14 second stop
15 projection
16 first bearing surface
20 second arm
21 first locking element
22 second locking element
24 second stop
30 connector
31 first opening
32 second opening
32a second opening (first sub-area)
32b second opening (second sub-area)
34 first receptacle
36 second receptacle
37 blocking element
38 main locking element
39 secondary locking
40 mating connector
42 snap-in opening
50 connector arrangement
A1 first bearing point
A2 second bearing point
M center axis
P1 first position
P2 second position
X first direction
Y second direction
Z third direction

What is claimed is:

1. A securing element for a connector, the securing element comprising:
a first and a second arm extending along a first direction;
a base connecting the first arm and the second arm at a free end;
at least a first locking element disposed on each arm such that the securing element is lockable to the connector in a second direction; and
at least one second locking element is disposed on each arm such that the securing element is lockable to the connector in a third direction.

2. The securing element according to claim 1, wherein the second direction is arranged transversely to the third direction.

3. The securing element according to claim 2, wherein the second and third directions are arranged transversely to the first direction.

4. The securing element according to claim 3, wherein the second direction is arranged perpendicularly to the third direction, and wherein the second and third directions are arranged perpendicularly to the first direction.

5. The securing element according to claim 1, wherein the first arm is configured flexibly and/or the second arm is configured rigidly.

6. The securing element according to claim 1, wherein the first arm is deflectable in a direction of the second arm.

7. The securing element according to claim 1, wherein the first arm has a projection at a free end.

8. The securing element according to claim 1, wherein the securing element is asymmetric with respect to a plane extending in the third direction along a center axis.

9. A connector, comprising:
a first receptacle configured to receive a mating connector;
a main locking element configured to lock the connector to the mating connector in the mated state;
a second receptacle configured to receive a securing element; and
the securing element, which is configured to secure the locking with the mating connector, the securing element comprising:
a first and a second arm extending along a first direction;
a base connecting the first arm and the second arm at a free end;
at least a first locking element disposed on each arm, so that the securing element is lockable to the connector in a second direction; and
at least one second locking element is disposed on each arm, so that the securing element is lockable to the connector in a third direction.

10. The connector according to claim 9, wherein the connector has at least first and second openings, the first locking elements being engagable with the first openings, and the second locking elements being engagable with the second openings.

11. The connector according to claim 10, wherein each of the first openings comprises a contiguous area and each of the second openings comprises at least two separate sub-areas.

12. The connector according to claim 9, wherein the main locking element is blocked by the securing element at at least a first and a second bearing point in an end-engagement position of the securing element.

13. A connector arrangement comprising the connector according to claim 9 and the mating connector that is detachably connectable to the connector.
